(19) United States
(12) Patent Application Publication
(10) Pub. No.: US 2015/0023744 A1
(43) Pub. Date: Jan. 22, 2015

(54) CUTTING INSERT WITH CHIP DIVIDERS

(71) Applicant: Kennametal Inc., Latrobe, PA (US)

(72) Inventors: Qiang Wu, North Huntingdon, PA (US); Nicholas J. Henry, Greensburg, PA (US); Christoph Gey, Zirndorf (DE); Horst Manfred Jaeger, Nurnberg (DE)

(73) Assignee: Kennametal Inc., Latrobe, PA (US)

(21) Appl. No.: 13/947,307

(22) Filed: Jul. 22, 2013

(51) Int. Cl. B23B 27/00

(52) U.S. Cl. CPC B23B 27/005; B23B 2200/0476; B23B 2200/0495; B23B 2200/087
USPC 407/116

(57) ABSTRACT

A cutting insert includes a polygonal body having an upper chip surface, a bottom surface and peripheral side surfaces extending between the upper chip surface and the bottom surface, the peripheral side surfaces intersecting the upper chip surface to form cutting edges therewith. A plurality of chip dividers are spaced apart about a perimeter of the upper chip surface to divide the chips produced by the cutting edges, each chip divider including a leading chip dividing portion adjacent to the cutting edge and extending generally upwardly from the cutting edge, the leading chip dividing portion having an elongated, rounded face. Adjacent chip dividers define a pocket such that the pockets are configured for promoting curling of chips produced by the cutting edges.

### BACKGROUND OF THE INVENTION

The invention pertains generally to a cutting insert to be used in cutting tools during machining operations. More specifically, the invention pertains to a cutting insert having a chip breaker that includes chip dividers to provide effective chip control during machining operations.

Cutting inserts of various geometries for use with many types of cutting tools during a machining operation are generally known. Such inserts typically include a cutting edge formed at the intersection of two of the walls of the insert body. When such inserts are mounted in a milling head or drill that is rotated and engaged against a metal workpiece, the cutting edges remove metal from the workpiece in the form of, for example, ribbon-like metal chips. Such metal chips can interfere with the cutting operation if they are not continuously removed from the vicinity of the cutting operation.

Accordingly, many inserts are manufactured with a chipbreaking geometry that continuously embrittles and breaks the chips as they are formed by the cutting edge, i.e. that provide effective chip control. Chip control during cutting operations becomes more challenging and important when working with long chipping materials which are typically more difficult to break and efficiently evacuate from the vicinity of the cutting operation.

Thus, there is a continual need for improved cutting inserts that overcome disadvantages, limitations and shortcomings of known cutting inserts. In addition, there is a continual need for improved cutting inserts that can provide improved chip control for long chipping materials.

### SUMMARY OF THE INVENTION

In accordance with an aspect of the invention, a cutting insert for cutting a workpiece by removing chips of material therefrom includes a polygonal body having an upper chip surface, a bottom surface and peripheral side surfaces extending between the upper chip surface and the bottom surface, the peripheral side surfaces intersecting the upper chip surface to form cutting edges therewith, and land surfaces disposed adjacent the cutting edges. The cutting insert also includes a plurality of chip dividers disposed about a periphery of the upper chip surface to divide the chips produced by the cutting edges, each chip divider including a leading chip dividing portion having an elongated face and extending generally angularly upwardly adjacent to the land surface. Adjacent chip dividers define a pocket configured for promoting curling of the chips produced by the cutting edges, the pocket having a rake face adjacent the land surface, opposing side walls extending upward from the rake face and a generally arcuate back wall interconnected with the rake face and the opposing side walls.

In accordance with another aspect of the invention, a cutting insert for cutting a workpiece by removing chips of material therefrom includes a polygonal body having an upper chip surface, a bottom surface and peripheral side surfaces extending between the upper chip surface and the bottom surface, the peripheral side surfaces intersecting the upper chip surface to form cutting edges therewith, and land surfaces disposed adjacent the cutting edges. The cutting insert also includes a plurality of chip dividers disposed about a periphery of the upper chip surface to divide the chips produced by the cutting edges, each chip divider including a leading chip dividing portion having an elongated face and extending generally angularly upwardly adjacent to the land surface. Adjacent chip dividers define a pocket configured for promoting curling of the chips produced by the cutting edges, the pocket including a bottom region having a rake face portion adjacent the land surface and a back wall portion rearward of the rake face portion, and opposing side walls extending upward from the rake face portion and the back wall portion.

In accordance with yet another aspect of the invention, a cutting insert for cutting a workpiece by removing chips of material therefrom includes a polygonal body having an upper chip surface, a bottom surface and peripheral side surfaces extending between the upper chip surface and the bottom surface, the peripheral side surfaces intersecting the upper chip surface to form cutting edges therewith. The cutting insert also includes a plurality of chip dividers spaced apart and disposed at least partially about a perimeter of the upper chip surface to divide the chips produced by the cutting edges, each chip divider including a leading chip dividing portion adjacent to the cutting edge and extending generally upwardly from the cutting edge, the leading chip dividing portion having an elongated, rounded face. Adjacent chip dividers define a pocket having a rake face adjacent the cutting edge, a back wall rearward of the rake face and opposing side walls extending rearward from respective leading chip dividing portions of the adjacent chip dividers such that the pockets are configured for promoting curling of the chips produced by the cutting edges.

These and other aspects of the present invention will be more fully understood following a review of this specification and drawings.

### BRIEF DESCRIPTION OF THE DRAWINGS

FIG. 1 is a top isometric view of a cutting insert, in accordance with an aspect of the invention.

FIG. 1A is an enlarged view of a portion labeled 1A of FIG. 1, in accordance with an aspect of the invention.

FIG. 1B is a sectional view taken along line 1B-1B of FIG. 1A, in accordance with an aspect of the invention.

FIG. 2 is a top view of the cutting insert shown in FIG. 1, in accordance with an aspect of the invention.

FIG. 3 is a front elevational view of the cutting insert shown in FIG. 2, in accordance with an aspect of the invention.

FIG. 4 is a rear elevational view of the cutting insert shown in FIG. 2, in accordance with an aspect of the invention.

FIG. 5 is a left side elevational view of the cutting insert shown in FIG. 2, in accordance with an aspect of the invention.

FIG. 6 is a right side elevational view of the cutting insert shown in FIG. 2, in accordance with an aspect of the invention.

FIG. 7 is a bottom isometric view of the cutting insert shown in FIG. 1, in accordance with an aspect of the invention.

FIG. 8 is a bottom view of the cutting insert shown in FIG. 2, in accordance with an aspect of the invention.

FIG. 9 is a top isometric view of another cutting insert, in accordance with an aspect of the invention.

FIG. 10 is a top view of the cutting insert shown in FIG. 9, in accordance with an aspect of the invention.

FIG. 11 is a front elevational view of the cutting insert shown in FIG. 10, in accordance with an aspect of the invention.

FIG. 12 is a rear elevational view of the cutting insert shown in FIG. 10, in accordance with an aspect of the invention.

FIG. 13 is a left side elevational view of the cutting insert shown in FIG. 10, in accordance with an aspect of the invention.

FIG. 14 is a right side elevational view of the cutting insert shown in FIG. 10, in accordance with an aspect of the invention.

FIG. 15 is a bottom isometric view of the cutting insert shown in FIG. 9, in accordance with an aspect of the invention.

FIG. 16 is a bottom view of the cutting insert shown in FIG. 10, in accordance with an aspect of the invention.

FIG. 17 is a top isometric view of an additional cutting insert, in accordance with an aspect of the invention.

FIG. 17A is an enlarged view of a portion labeled 17A of FIG. 17, in accordance with an aspect of the invention.

FIG. 17B is a sectional view taken along line 17B-17B of FIG. 17A, in accordance with an aspect of the invention.

FIG. 18 is a top view of the cutting insert shown in FIG. 17, in accordance with an aspect of the invention.

FIG. 19 is a front elevational view of the cutting insert shown in FIG. 18, in accordance with an aspect of the invention.

FIG. 20 is a rear elevational view of the cutting insert shown in FIG. 18, in accordance with an aspect of the invention.

FIG. 21 is a left side elevational view of the cutting insert shown in FIG. 18, in accordance with an aspect of the invention.

FIG. 22 is a right side elevational view of the cutting insert shown in FIG. 18, in accordance with an aspect of the invention.

FIG. 23 is a bottom isometric view of the cutting insert shown in FIG. 17, in accordance with an aspect of the invention.

FIG. 24 is a bottom view of the cutting insert shown in FIG. 18, in accordance with an aspect of the invention.

FIG. 25 is a top isometric view of a cutting insert, in accordance with an aspect of the invention.

FIG. 26 is a top view of the cutting insert shown in FIG. 25, in accordance with an aspect of the invention.

FIG. 27 is a front elevational view of the cutting insert shown in FIG. 26, in accordance with an aspect of the invention.

FIG. 28 is a rear elevational view of the cutting insert shown in FIG. 26, in accordance with an aspect of the invention.

FIG. 29 is a left side elevational view of the cutting insert shown in FIG. 26, in accordance with an aspect of the invention.

FIG. 30 is a right side elevational view of the cutting insert shown in FIG. 26, in accordance with an aspect of the invention.

FIG. 31 is a bottom isometric view of the cutting insert shown in FIG. 25, in accordance with an aspect of the invention.

FIG. 32 is a bottom view of the cutting insert shown in FIG. 26, in accordance with an aspect of the invention.

### DETAILED DESCRIPTION

The following description is for purposes of illustrating various aspects of the invention only and not for purposes of limiting the scope of the invention.

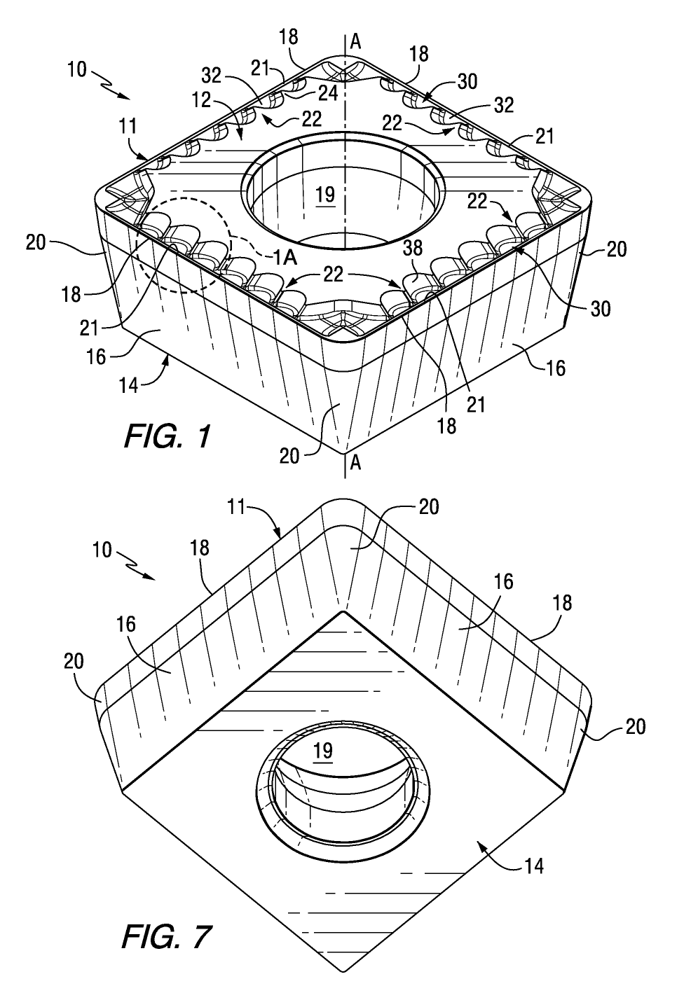

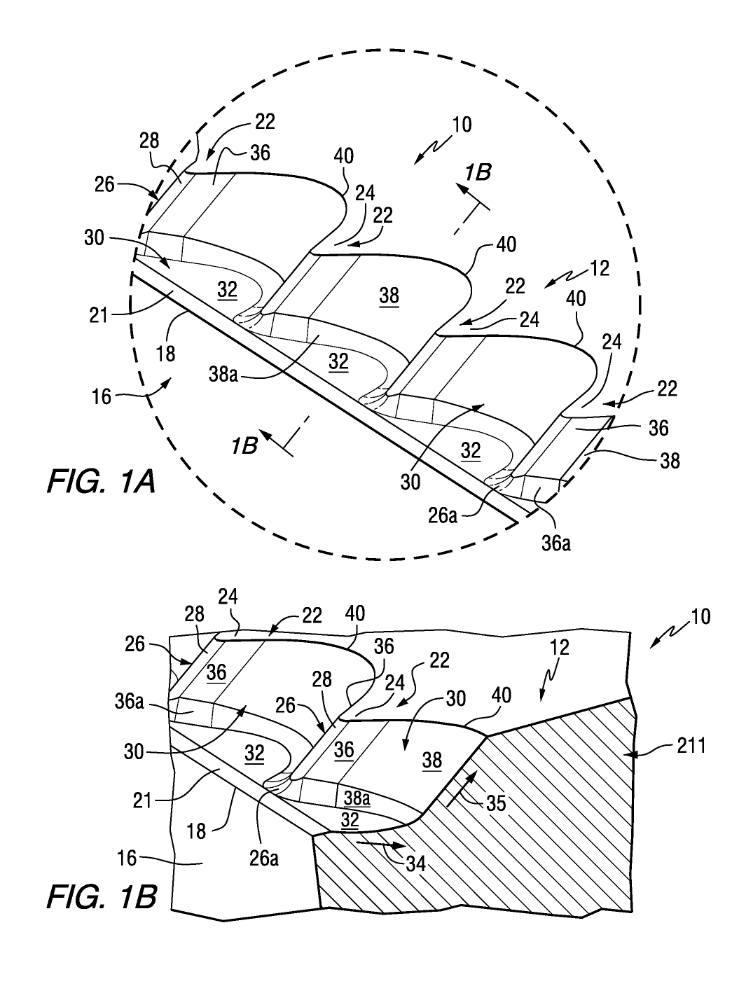

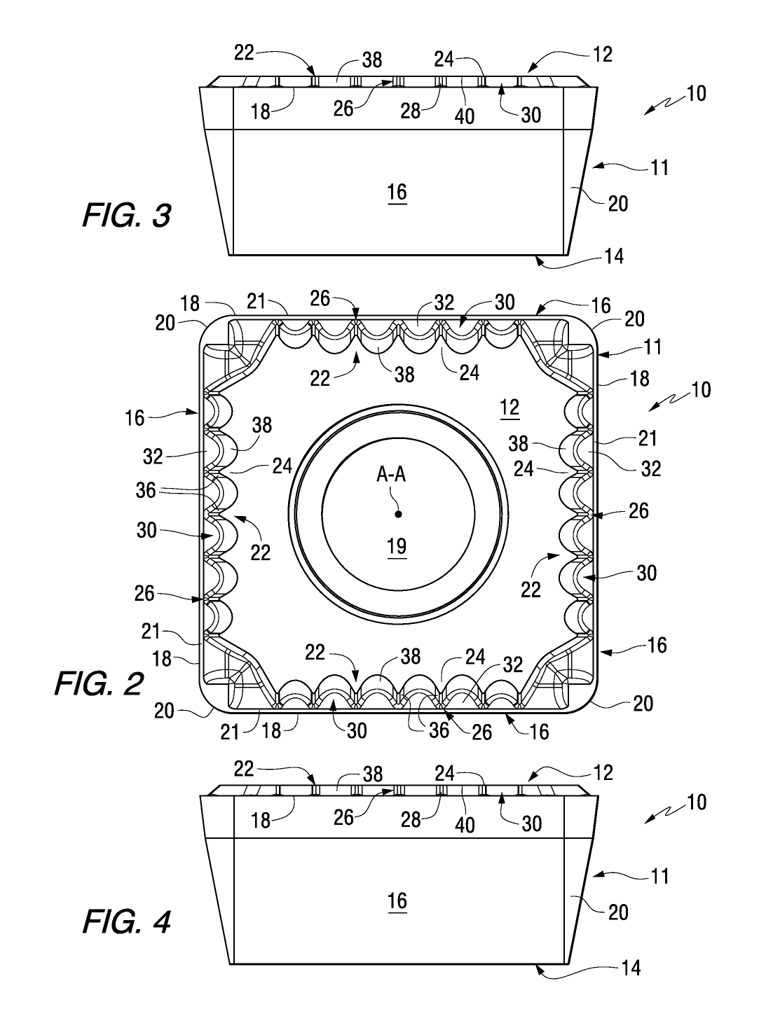

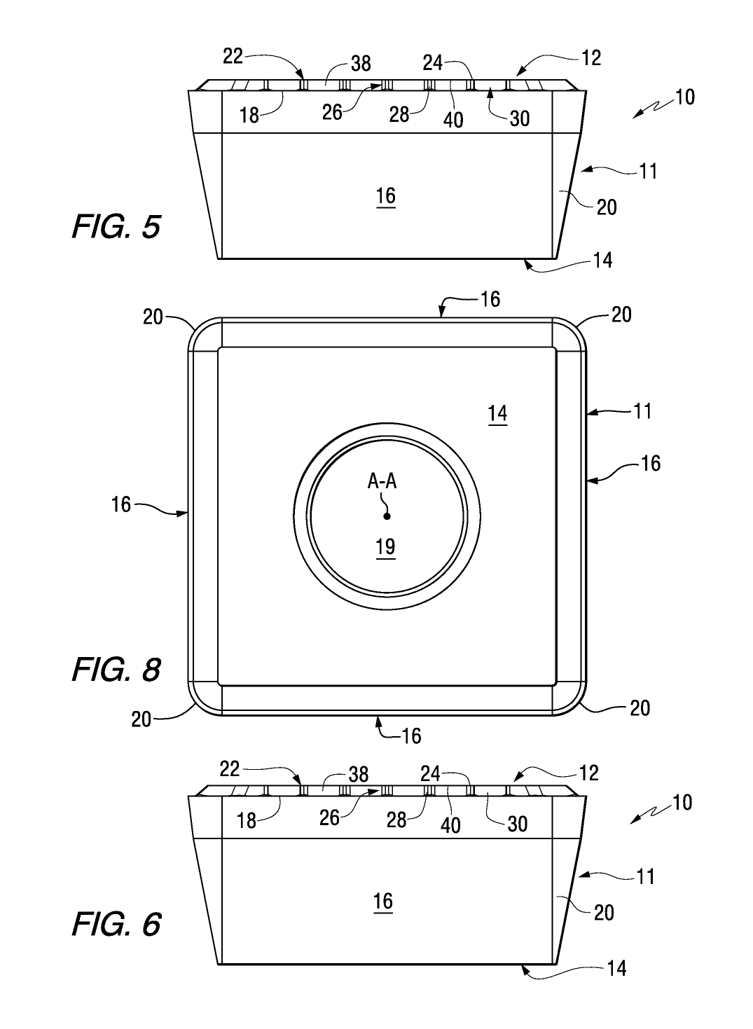

Referring to FIGS. 1-8, there is illustrated a cutting insert, generally designated as reference number 10 for use in association with a cutting tool (not shown) for performing a cutting operation, e.g. cutting a workpiece by removing chips of material therefrom, in accordance with an aspect of the invention. The cutting insert 10 includes a body 11 having an upper chip surface 12 (which may also be referred to as, for example, an upper surface or a top surface), a bottom surface 14 (which may also be referred to as, for example, a seating surface or bottom seating surface) and peripheral side surfaces 16 (which may also be referred to as, for example, sides, plurality of sides, flanks or flank faces) extending between the upper chip surface 12 and the bottom surface 14. The cutting insert 10 includes a central axis A-A which extends through or passes through the upper chip surface 12 and the bottom surface 14.

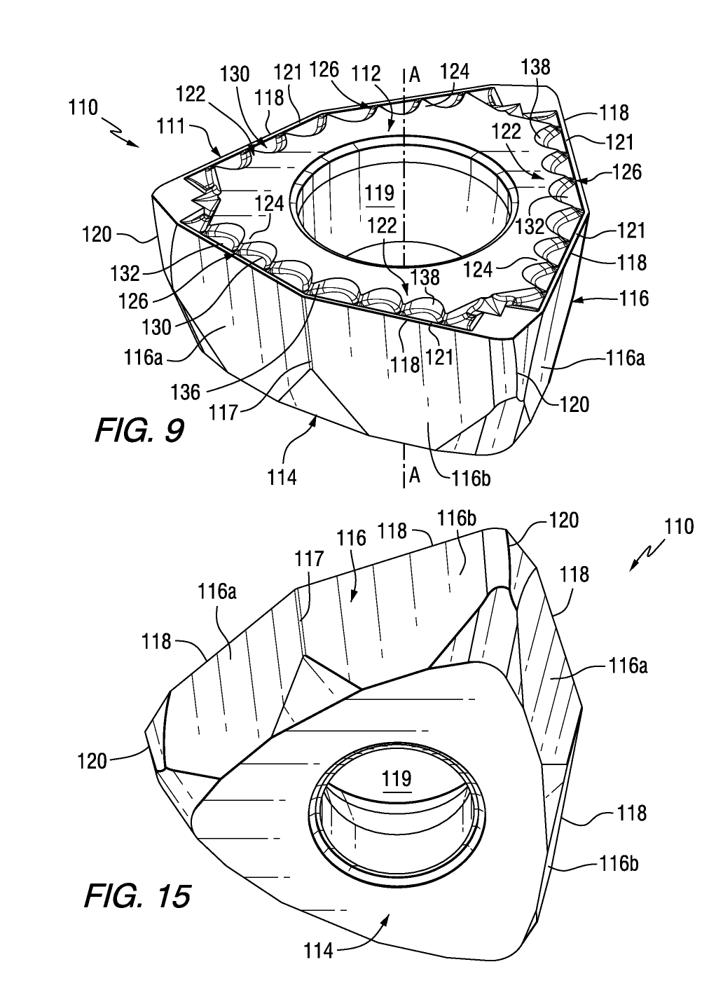

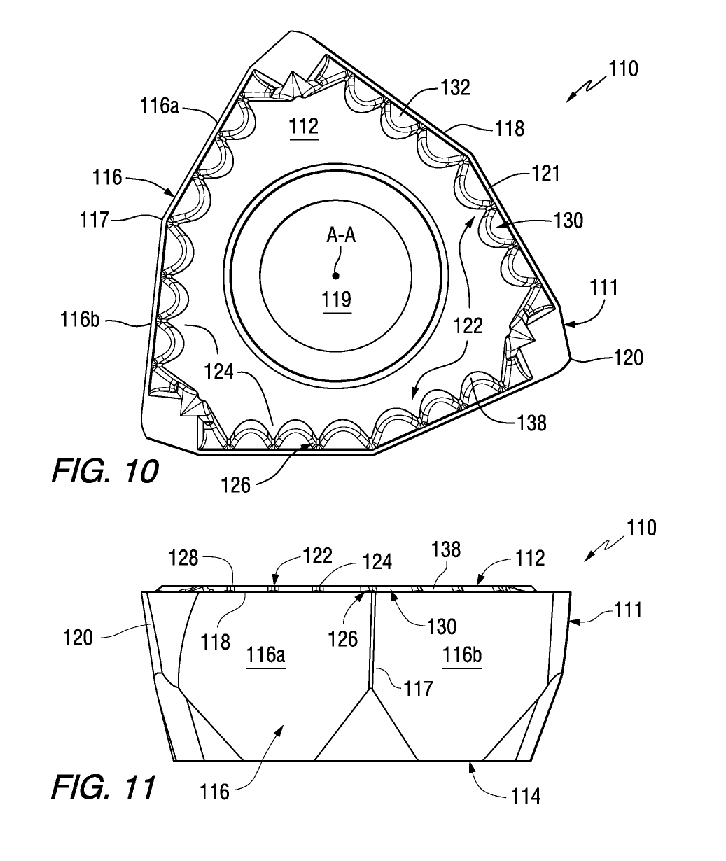

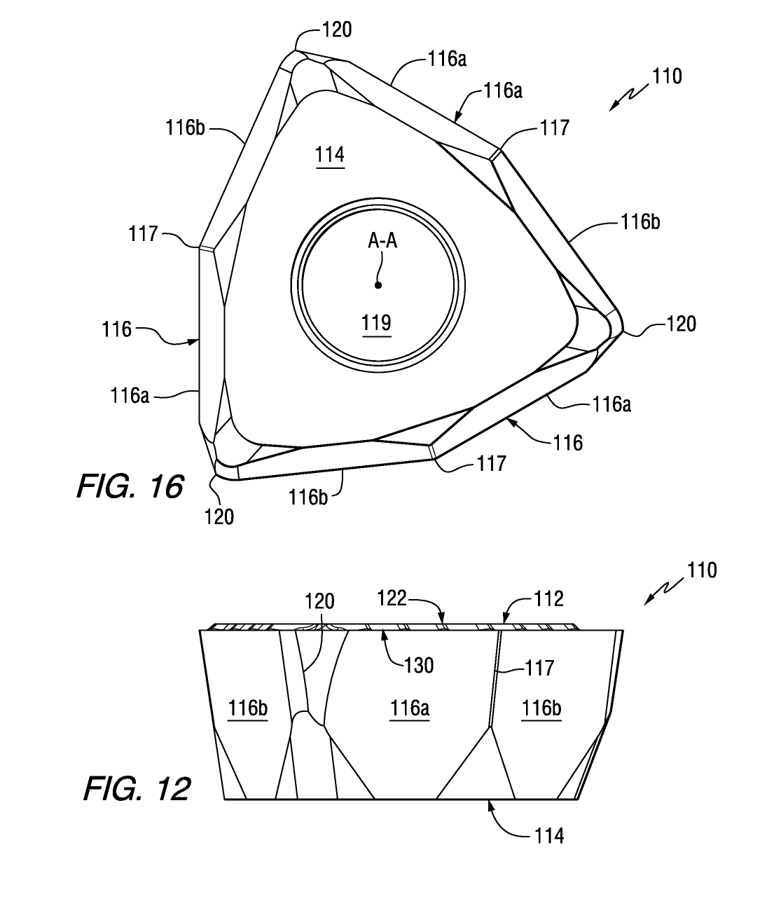

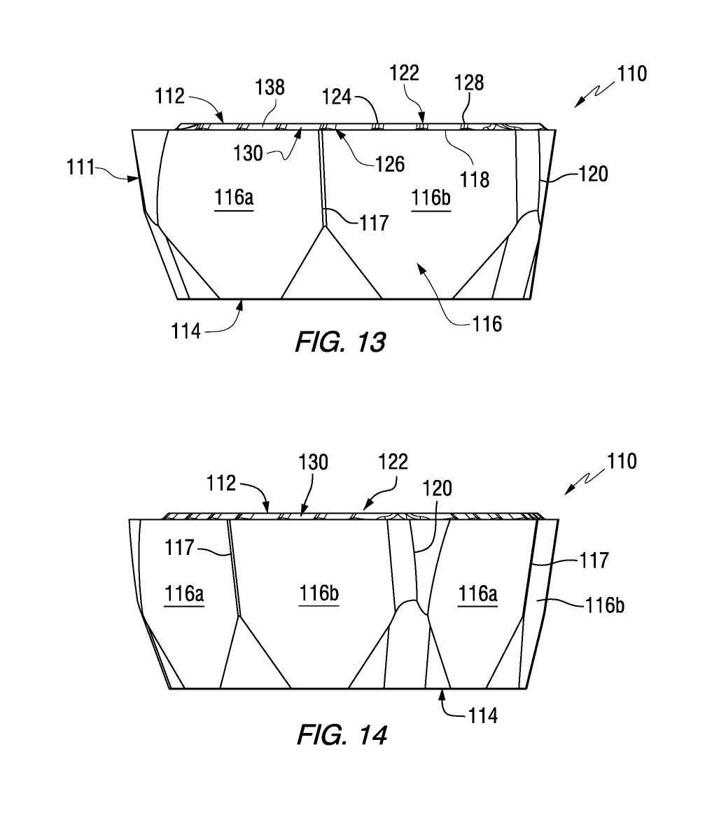

In one aspect, the body 11 of the cutting insert 10 is configured to be polygonal. While a generally square or generally rectangular cutting insert 10 having four sides is shown in the FIGS. 1-8 for illustrative purposes only, it will be appreciated that other multi-sided or polygonal shapes (e.g. trigonal or triangular as shown in FIGS. 9-16, rectangular, pentagonal, etc.) may be utilized for the cutting insert of the present invention. In another aspect, the body 11 of the cutting insert 10 is configured to be an indexable type cutting insert. In yet another aspect of the invention, the body 11 of the cutting insert 10 is configured so that the peripheral side surfaces 16 slope or slant generally inwardly from the upper chip surface 12 to the bottom surface 14 such that the bottom surface 14 is smaller than the upper chip surface 12. The body 11 also can include a central aperture 19 to provide, for example, mounting the cutting insert 10 in a cutting tool (not shown) as is known. The cutting insert 10 further includes a radiused corner portion 20 that connects two adjacent peripheral side surfaces 16.

Still referring to FIGS. 1-8, the cutting insert 10 also includes cutting edges 18 defined at the juncture or intersection of each of the peripheral side surfaces 16 and the upper chip surface 12. In one aspect, each cutting edge 18 is generally a linear or straight edge that extends from a corresponding radiused corner portion 20 to an adjacent corresponding radiused corner portion 20. However, it will be appreciated that the cutting edges 18 may have other shapes and configurations, such as, for example, curved, arcuate, concave, convex or combinations thereof.

In another aspect, the upper chip surface 12 includes land surfaces 21 disposed adjacent the cutting edges 18. The land surfaces 21 may be generally flat or planar surfaces that extend inwardly from the cutting edges 18 away from the peripheral side surfaces 16.

In another aspect of the invention, the cutting insert 10 includes a plurality of chip dividers 22 defined by the upper chip surface 12. The chip dividers 22 are at least partially disposed about a periphery or perimeter of the upper chip surface 12 to divide, split, or separate the chips produced by the cutting edges 18. The chip dividers 22 include a top surface 24. In addition, each chip divider 22 includes a leading chip dividing portion 26 having an elongated face 28. In one aspect, leading chip dividing portion 26 is adjacent to the land surface 21 and/or the cutting edge 18 and extends generally upwardly therefrom to the top surface 24 of the chip divider 22. In one example, the leading chip dividing portion 26 extends generally angularly upwardly so as to be slanted or sloped with respect to the top surface 24 of the chip divider and/or with respect to the upper chip surface 12. In one aspect, the elongated face 28 of the leading chip dividing portion 26 is rounded, but can include other shapes or configurations suitable for dividing the chips.

As illustrated, for example, in FIG. 1B, chip dividers 22 that are adjacent to or next to one another define a pocket 30 configured for promoting curling of the chips produced by the cutting edges 18. In one aspect, the pockets 30 are adjacent to and extend generally inwardly from the land surfaces 21 and/or the cutting edges 18. In one aspect, the pockets extend generally inwardly away from the peripheral side surfaces 16 of the insert body 11. Thus, the pockets 30 improve and enhance chip control during cutting operations so as to more efficiently evacuate or remove the chips from the vicinity of the cutting operation particularly for long chipping materials which are typically more difficult to break and efficiently evacuate.

Each of the pockets 30 includes a rake face 32 adjacent to the land surfaces 21. Alternatively, it will be appreciated that the rake faces 32 could be adjacent to the cutting edges 18 if no land surface 21 is provided. In one aspect, the rake face 32 of each pocket 30 slopes, slants and/or curves generally downwardly away from the land surfaces 21 or the cutting edges 18 as illustrated, for example, by arrow 34 in FIG. 1B. The pockets 30 further include opposing side walls 36 extending upward from the rake face 32 and a back wall 38 interconnected with the rake face 32 and/or the opposing side walls 36. In one aspect, the back wall 38 of each pocket 30 slopes, slants and/or curves generally upwardly away from the rake face 32 as illustrated, for example, by arrow 35 in FIG. 1B.

In another aspect of the invention, the back wall 38 can have a generally arcuate, curved or rounded shape or configuration or other shapes and configurations suitable for providing or promoting the desired chip curling. In addition, the back walls 38 of the pockets 30 terminate in an upper edge 40 on the upper chip surface 12 such that the upper edges 40 of the back walls 38 are elevated above the cutting edges 18. In one aspect, the upper edges 40 are contained in a plane that is non-coplanar with and elevated above a plane containing the cutting edges 18. The upper edges 40 of back wall 38 can have a generally arcuate, curved or rounded shape or configuration or other shapes and configurations similar to or corresponding to the shape or configuration of the back wall 38 suitable for providing or promoting the desired chip curling.

In another aspect of the invention, the pockets 30 can have intermediate side walls 36a between the rake face 32 and each of the opposing side walls 36. The pockets 30 can have intermediate back walls 38a between the rake face 32 and the back wall 38, wherein each intermediate back wall 38a is interconnected with the intermediate side walls 36a. In addition, each chip divider 22 can have an intermediate leading chip dividing portion 26a between the land surface 21 or the cutting edges 18 and the leading chip dividing portion 26.

Referring to FIGS. 9-16, there is illustrated another cutting insert, generally designated as reference number 110 for use in association with a cutting tool (not shown) for performing a cutting operation, e.g. cutting a workpiece by removing chips of material therefrom, in accordance with an aspect of the invention. The cutting insert 110 is similar to cutting insert 10 as described and illustrated herein, except that cutting insert 110 has a trigonal or triangular shape.

The cutting insert 110 includes a body 111 having an upper chip surface 112 (which may also be referred to as, for example, an upper surface or a top surface), a bottom surface 114 (which may also be referred to as, for example, a seating surface or bottom seating surface) and peripheral side surfaces 116 (which may also be referred to as, for example, sides, plurality of sides, flanks or flank faces) extending between the upper chip surface 112 and the bottom surface 114. The cutting insert 110 includes a central axis A-A which extends through or passes through the upper chip surface 112 and the bottom surface 14.

In one aspect, the body 111 of the cutting insert 110 is configured to be polygonal. More particularly, the cutting insert 110 is configured to have a trigonal or triangular shape. Thus, each peripheral side surface 116 includes an obtuse corner 117 that separates each peripheral side surface 116 into a first portion 116a and a second portion 116b.

In another aspect, the body 111 of the cutting insert 110 is configured to be an indexable type cutting insert. In yet another aspect of the invention, the body 111 of the cutting insert 110 is configured so that the peripheral side surfaces 116 (e.g. first portions 116a and second portions 116b) slope or slant generally inwardly from the upper chip surface 112 to the bottom surface 114 such that the bottom surface 114 is smaller than the upper chip surface 112. The body 111 also can include a central aperture 119 to provide, for example, mounting the cutting insert 110 in a cutting tool (not shown) as is known. The cutting insert 110 further includes a radiused corner portion 120 that connects two adjacent peripheral side surfaces 116.

Still referring to FIGS. 9-16, the cutting insert 110 also includes cutting edges 118 defined at the juncture or intersection of each of the peripheral side surfaces 116 (e.g. first portions 116a and second portions 116b) and the upper chip surface 112. In another aspect, the upper chip surface 112 includes land surfaces 121 disposed adjacent the cutting edges 118. The land surfaces 121 may be generally flat or planar surfaces that extend inwardly from the cutting edges 118 away from the peripheral side surfaces 116.

In another aspect of the invention, the cutting insert 110 includes a plurality of chip dividers 122 defined by the upper chip surface 112. The chip dividers 122 are at least partially disposed about a periphery or perimeter of the upper chip surface 112 to divide, split, or separate the chips produced by the cutting edges 118. The chip dividers 122 include a top surface 124. In addition, each chip divider 122 includes a leading chip dividing portion 126 having an elongated face. In one aspect, leading chip dividing portion 126 is adjacent to the land surface 121 and/or the cutting edge 118 and extends generally upwardly therefrom to the top surface 124 of the chip divider 122. In one example, the leading chip dividing portion 126 extends generally angularly upwardly so as to be slanted or sloped with respect to the top surface 124 of the chip divider and/or with respect to the upper chip surface 112. In one aspect, the elongated face of the leading chip dividing portion 126 is rounded, but can include other shapes or configurations suitable for dividing the chips.

In another aspect of the invention, chip dividers 122 that are adjacent to or next to one another define a pocket 130 configured for promoting curling of the chips produced by the cutting edges 118. In one aspect, the pockets 130 are adjacent to and extend generally inwardly from the land surfaces 121 and/or the cutting edges 118. In one aspect, the pockets extend generally inwardly away from the peripheral side surfaces 116 of the insert body 111. Thus, the pockets 130 improve and enhance chip control during cutting operations so as to more efficiently evacuate or remove the chips from the vicinity of the cutting operation particularly for long chipping materials which are typically more difficult to break and efficiently evacuate.

Each of the pockets 130 includes a rake face 132, opposing side walls 136 extending upward from the rake face 132 and a back wall 138 interconnected with the rake face 132 and/or the opposing side walls 136.

It will be appreciated that the pockets 132 and the chip dividers 122 are configured essentially the same as pockets 32 and chip dividers 22 and function in essentially the same manner for providing and promoting the desired chip curling.

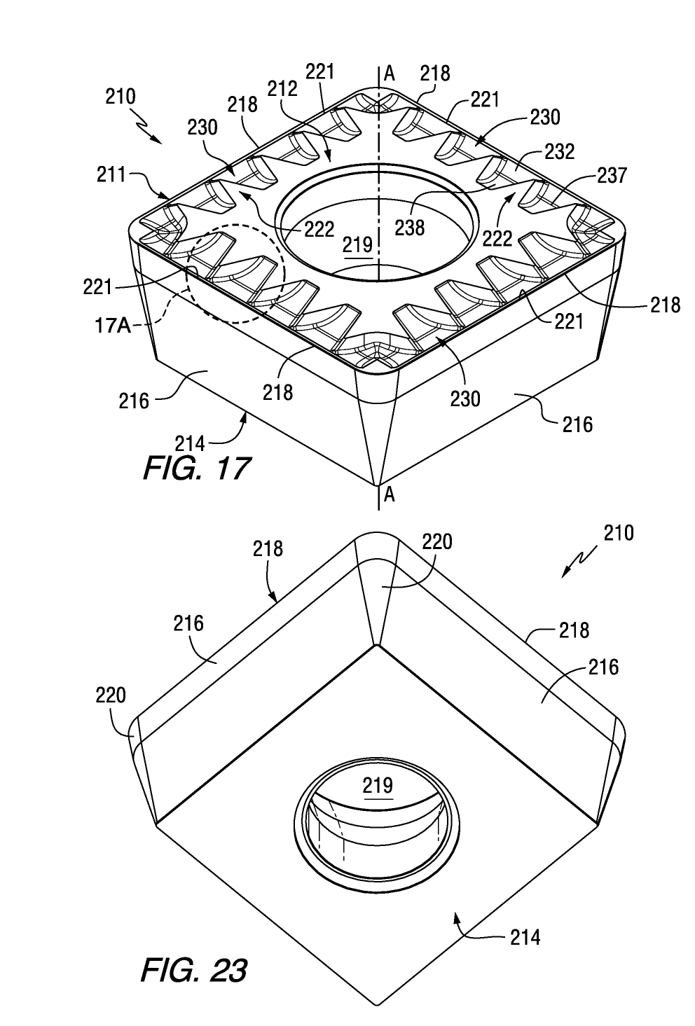

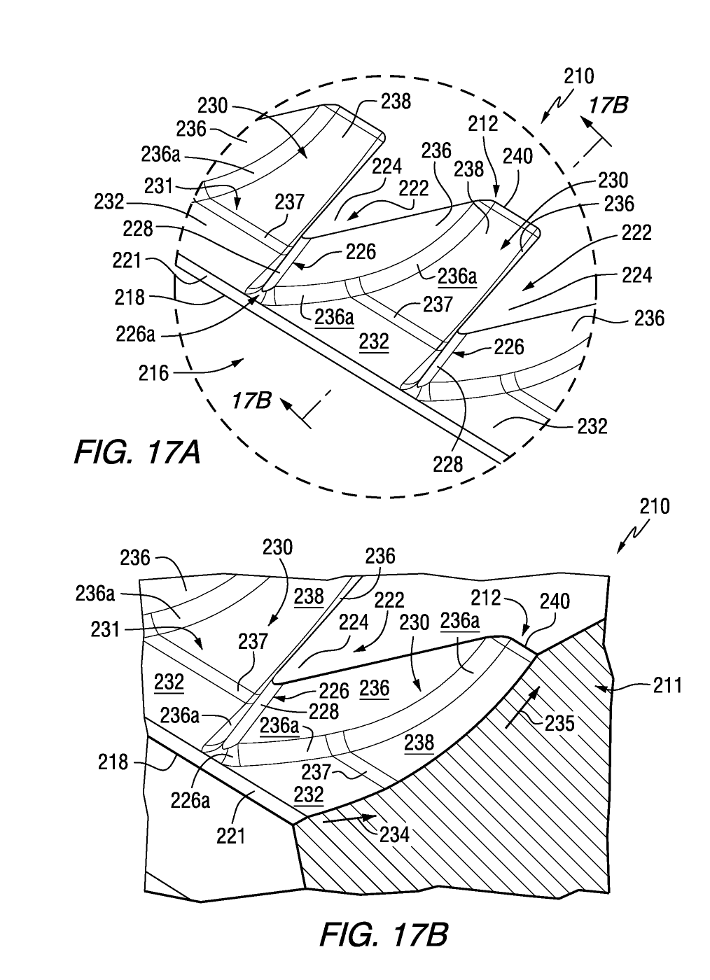

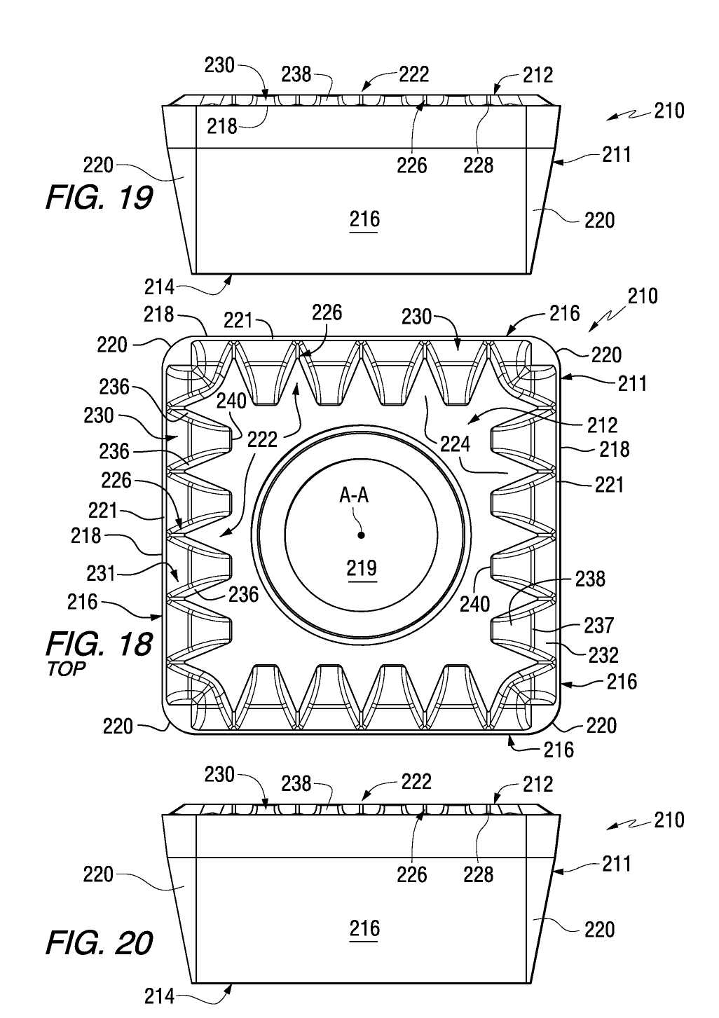

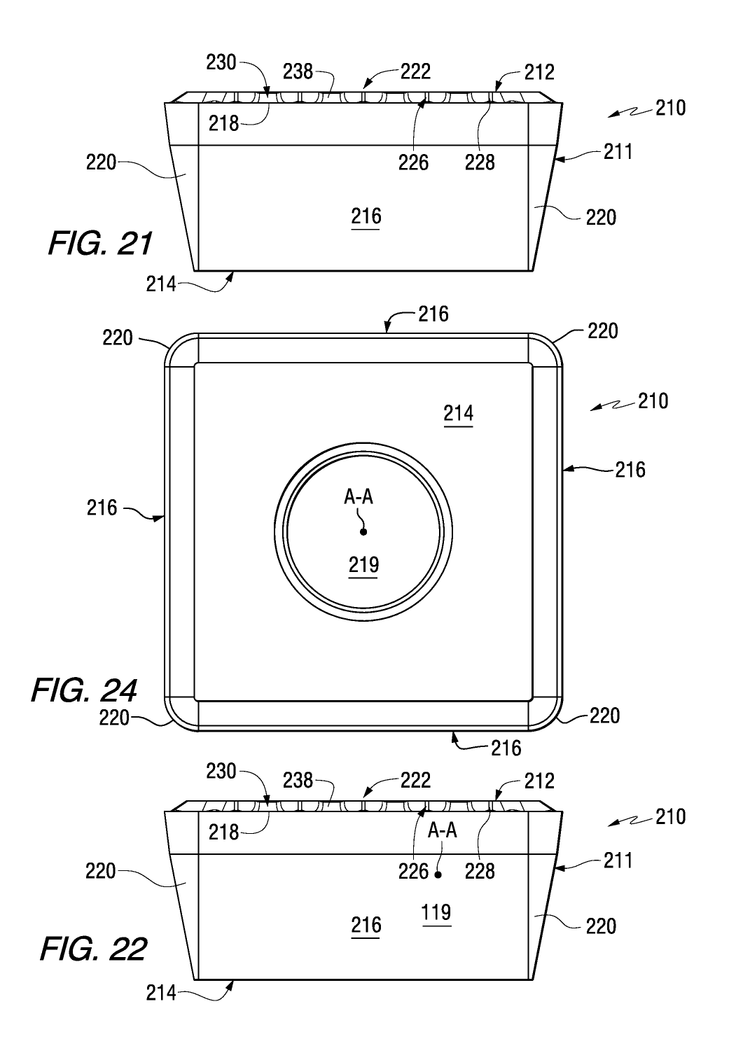

Referring to FIGS. 17-24, there is illustrated an additional cutting insert, generally designated as reference number 210 for use in association with a cutting tool (not shown) for performing a cutting operation, e.g. cutting a workpiece by removing chips of material therefrom, in accordance with an aspect of the invention. The cutting insert 210 includes a body 211 having an upper chip surface 212 (which may also be referred to as, for example, an upper surface or a top surface), a bottom surface 214 (which may also be referred to as, for example, a seating surface or bottom seating surface) and peripheral side surfaces 216 (which may also be referred to as, for example, sides, plurality of sides, flanks or flank faces) extending between the upper chip surface 212 and the bottom surface 214. The cutting insert 210 includes a central axis A-A which extends through or passes through the upper chip surface 212 and the bottom surface 214.

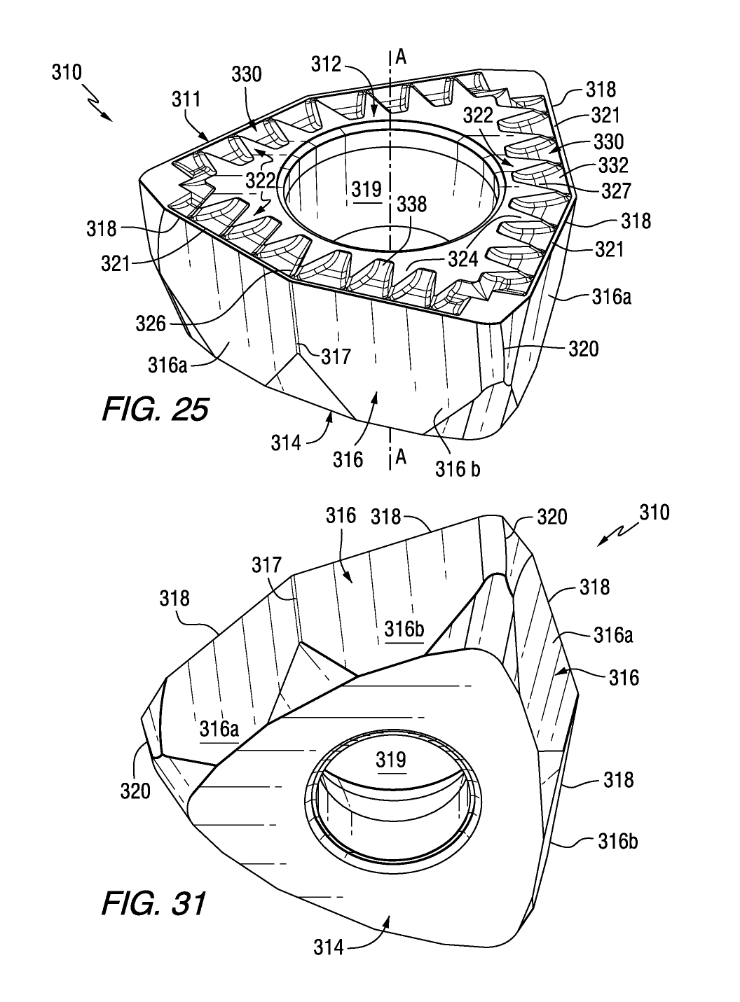

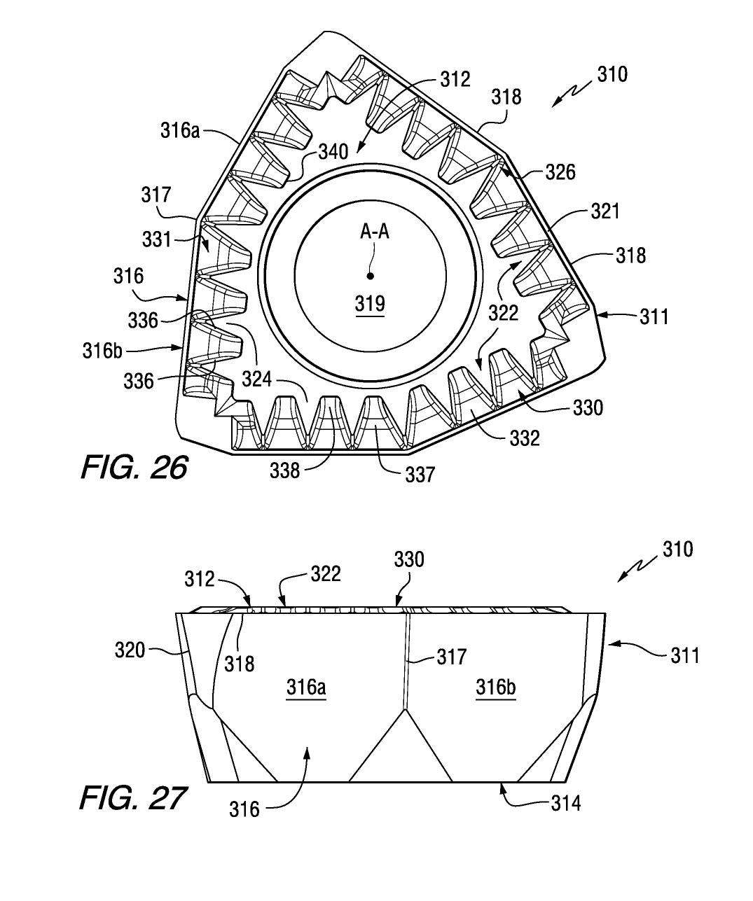

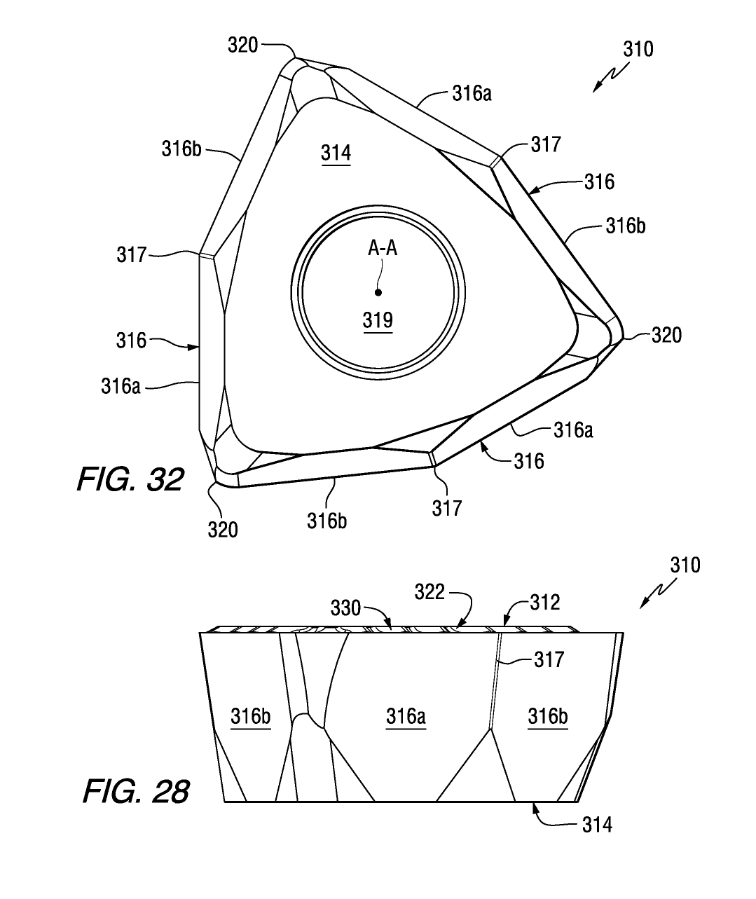

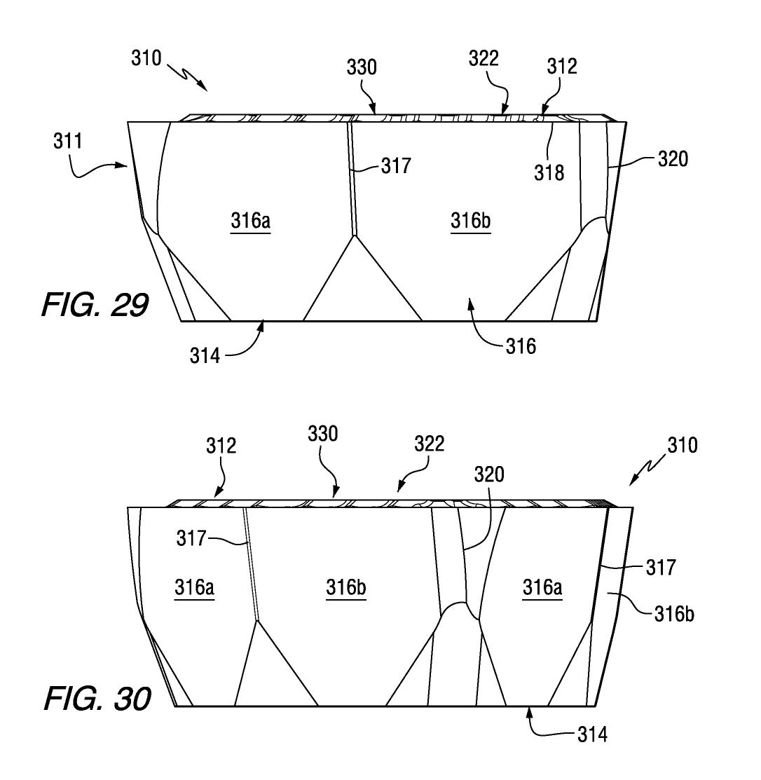

In one aspect, the body 211 of the cutting insert 210 is configured to be polygonal. While a generally square or generally rectangular cutting insert 210 having four sides is shown in the FIGS. 17-24 for illustrative purposes only, it will be appreciated that other multi-sided or polygonal shapes (e.g. trigonal or triangular as shown in FIGS. 25-32, rectangular, pentagonal, etc.) may be utilized for the cutting insert of the present invention. In another aspect, the body 211 of the cutting insert 210 is configured to be an indexable type cutting insert. In yet another aspect of the invention, the body 211 of the cutting insert 210 is configured so that the peripheral side surfaces 216 slope or slant generally inwardly from the upper chip surface 212 to the bottom surface 214 such that the bottom surface 214 is smaller than the upper chip surface 212. The body 211 also can include a central aperture 219 to provide, for example, mounting the cutting insert 210 in a cutting tool (not shown) as is known. The cutting insert 210 further includes a radiused corner portion 220 that connects two adjacent peripheral side surfaces 216.

Still referring to FIGS. 17-24, the cutting insert 210 also includes cutting edges 218 defined at the juncture or intersection of each of the peripheral side surfaces 216 and the upper chip surface 212. In one aspect, each cutting edge 218 is generally a linear or straight edge that extends from a corresponding radiused corner portion 220 to an adjacent corresponding radiused corner portion 220. However, it will be appreciated that the cutting edges 218 may have other shapes and configurations, such as, for example, curved, arcuate, concave, convex or combinations thereof.

In another aspect, the upper chip surface 212 includes land surfaces 221 disposed adjacent the cutting edges 218. The land surfaces 221 may be generally flat or planar surfaces that extend inwardly from the cutting edges 218 away from the peripheral side surfaces 216.

In another aspect of the invention, the cutting insert 210 includes a plurality of chip dividers 222 defined by the upper chip surface 212. The chip dividers 222 are at least partially disposed about a periphery or perimeter of the upper chip surface 212 to divide, split, or separate the chips produced by the cutting edges 218. The chip dividers 222 include a top surface 224. In addition, each chip divider 222 includes a leading chip dividing portion 226 having an elongated face 228. In one aspect, leading chip dividing portion 226 is adjacent to the land surface 221 and/or the cutting edge 218 and extends generally upwardly therefrom to the top surface 224 of the chip divider 222. In one example, the leading chip dividing portion 226 extends generally angularly upwardly so as to be slanted or sloped with respect to the top surface 224 of the chip divider and/or with respect to the upper chip surface 212. In one aspect, the elongated face 228 of the leading chip dividing portion 226 is rounded, but can include other shapes or configurations suitable for dividing the chips.

As illustrated, for example, in FIG. 17B, chip dividers 222 that are adjacent to or next to one another define a pocket 230 configured for promoting curling of the chips produced by the cutting edges 218. In one aspect, the pockets 230 are adjacent to and extend generally inwardly from the land surfaces 221 and/or the cutting edges 218. In one aspect, the pockets extend generally inwardly away from the peripheral side surfaces 216 of the insert body 211. Thus, the pockets 230 improve and enhance chip control during cutting operations so as to more efficiently evacuate or remove the chips from the vicinity of the cutting operation particularly for long chipping materials which are typically more difficult to break and efficiently evacuate.

Each of the pockets 230 includes a bottom region 231 having a rake face portion 232 adjacent to the land surfaces 221. Alternatively, it will be appreciated that the rake face portions 232 could be adjacent to the cutting edges 218 if no land surface 221 is provided. In one aspect, the rake face portion 232 of each pocket 230 slopes, slants and/or curves generally downwardly away from the land surfaces 221 or the cutting edges 218 as illustrated, for example, by arrow 234 in FIG. 17B. The bottom region 231 of the pockets 230 also include a back wall portion 238 rearward of the rake face portions 232. The pockets 230 further include opposing side walls 236 extending upward from the rake face portion 232 and the back wall portion 238. In one from aspect, the back wall portion 238 of each pocket 230 slopes, slants and/or curves generally upwardly away the rake face portion 232 as illustrated, for example, by arrow 235 in FIG. 17B.

In addition, the bottom regions 231 of the pockets 230 include a transition zone 237 between the rake face portion 232 and the back wall portion 238 to provide for a transition between the rake face portions 232 sloping generally downwardly away from the land surfaces 231 and the back wall portions 238 sloping generally upwardly away from the rake face portions 232.

In another aspect of the invention, the back wall portion 238 can have a shape and configuration suitable for providing or promoting the desired chip curling. In addition, the back wall portions 238 of the pockets 230 terminate in an upper edge 240 on the upper chip surface 212 such that the upper edges 240 of the back wall portions 238 are elevated above the cutting edges 218. In one aspect, the upper edges 240 are contained in a plane that is non-coplanar with and elevated above a plane containing the cutting edges 218. The upper edges 240 of back wall portion 238 can have a generally straight or linear shape or configuration or other shapes and configurations similar to or corresponding to the shape or configuration of the back wall portion 238 suitable for providing or promoting the desired chip curling.

In another aspect of the invention, the pockets 230 can have intermediate side walls 236a between the rake face portion 232 and each of the opposing side walls 236 and between the back wall portions 238 and each of the opposing side walls 236. In addition, each chip divider 222 can have an intermediate leading chip dividing portion 226a between the land surface 221 or the cutting edges 218 and the leading chip dividing portion 226.

Referring to FIGS. 25-32, there is illustrated another cutting insert, generally designated as reference number 310 for use in association with a cutting tool (not shown) for performing a cutting operation, e.g. cutting a workpiece by removing chips of material therefrom, in accordance with an aspect of the invention. The cutting insert 310 is similar to cutting insert 210 as described and illustrated herein, except that cutting insert 310 has a trigonal or triangular shape.

The cutting insert 310 includes a body 311 having an upper chip surface 312 (which may also be referred to as, for example, an upper surface or a top surface), a bottom surface 314 (which may also be referred to as, for example, a seating surface or bottom seating surface) and peripheral side surfaces 316 (which may also be referred to as, for example, sides, plurality of sides, flanks or flank faces) extending between the upper chip surface 312 and the bottom surface 314. The cutting insert 310 includes a central axis A-A which extends through or passes through the upper chip surface 312 and the bottom surface 314.

In one aspect, the body 311 of the cutting insert 310 is configured to be polygonal. More particularly, the cutting insert 310 is configured to have a trigonal or triangular shape. Thus, each peripheral side surface 316 includes an obtuse corner 317 that separates each peripheral side surface 316 into a first portion 316a and a second portion 316b.

In another aspect, the body 311 of the cutting insert 310 is configured to be an indexable type cutting insert. In yet another aspect of the invention, the body 311 of the cutting insert 310 is configured so that the peripheral side surfaces 316 (e.g. first portions 316a and second portions 316b) slope or slant generally inwardly from the upper chip surface 312 to the bottom surface 314 such that the bottom surface 314 is smaller than the upper chip surface 312. The body 311 also can include a central aperture 319 to provide, for example, mounting the cutting insert 310 in a cutting tool (not shown) as is known. The cutting insert 310 further includes a radiused corner portion 320 that connects two adjacent peripheral side surfaces 316.

Still referring to FIGS. 25-32, the cutting insert 310 also includes cutting edges 318 defined at the juncture or intersection of each of the peripheral side surfaces 316 (e.g. first portions 316a and second portions 316b) and the upper chip surface 312. In another aspect, the upper chip surface 312 includes land surfaces 321 disposed adjacent the cutting edges 318. The land surfaces 321 may be generally flat or planar surfaces that extend inwardly from the cutting edges 318 away from the peripheral side surfaces 316.

In another aspect of the invention, the cutting insert 310 includes a plurality of chip dividers 322 defined by the upper chip surface 312. The chip dividers 322 are at least partially disposed about a periphery or perimeter of the upper chip surface 312 to divide, split, or separate the chips produced by the cutting edges 318. The chip dividers 322 include a top surface 324. In addition, each chip divider 322 includes a leading chip dividing portion 326 having an elongated face. In one aspect, leading chip dividing portion 326 is adjacent to the land surface 321 and/or the cutting edge 318 and extends generally upwardly therefrom to the top surface 324 of the chip divider 322. In one example, the leading chip dividing portion 326 extends generally angularly upwardly so as to be slanted or sloped with respect to the top surface 324 of the chip divider and/or with respect to the upper chip surface 312. In one aspect, the elongated face of the leading chip dividing portion 326 is rounded, but can include other shapes or configurations suitable for dividing the chips.

In another aspect of the invention, chip dividers 322 that are adjacent to or next to one another define a pocket 330 configured for promoting curling of the chips produced by the cutting edges 318. In one aspect, the pockets 330 are adjacent to and extend generally inwardly from the land surfaces 321 and/or the cutting edges 318. In one aspect, the pockets extend generally inwardly away from the peripheral side surfaces 316 of the insert body 311. Thus, the pockets 330 improve and enhance chip control during cutting operations so as to more efficiently evacuate or remove the chips from the vicinity of the cutting operation particularly for long chipping materials which are typically more difficult to break and efficiently evacuate.

Each of the pockets 330 includes a bottom region 331 having a rake face portion 332 adjacent to the land surfaces 321. The bottom region 331 of the pockets 330 also include a back wall portion 338 rearward of the rake face portions 332. The pockets 330 further include opposing side walls 336 extending upward from the rake face portion 332 and the back wall portion 338.

It will be appreciated that the pockets 332 and the chip dividers 322 are configured essentially the same as pockets 232 and chip dividers 222 and function in essentially the same manner for providing and promoting the desired chip curling.

For purposes of the description set forth herein, terms such as, for example, “upper”, “lower”, “right”, “left”, “front”, “back”, “rear”, “vertical”, “horizontal”, “top”, “bottom”, “lateral”, “longitudinal”, “upwardly”, “downwardly”, “angularly” and the like and derivatives thereof shall relate to the invention as it is oriented in the drawing figures. However, it is to be understood that the invention may assume various alternative variations, except where expressly specified to the contrary. It is also to be understood that the specific aspects of the invention illustrated in the attached drawings, and described in the specification, are simply exemplary aspects and embodiments of the invention. Hence, specific dimensions and other physical characteristics related to the aspects and embodiments disclosed herein are not to be considered as limiting.

Whereas particular aspects of this invention have been described above for purposes of illustration, it will be evident to those skilled in the art that numerous variations of the details of the present invention may be made without departing from the invention as defined in the appended claims.

What is claimed is:

1. A cutting insert for cutting a workpiece by removing chips of material therefrom, comprising:
a polygonal body having an upper chip surface, a bottom surface and peripheral side surfaces extending between the upper chip surface and the bottom surface, the peripheral side surfaces intersecting the upper chip surface to form cutting edges therewith, and land surfaces disposed adjacent the cutting edges; and
a plurality of chip dividers disposed about a periphery of the upper chip surface to divide the chips produced by the cutting edges, each chip divider including a leading chip dividing portion having an elongated face and extending generally angularly upwardly adjacent to the land surface,
wherein adjacent chip dividers define a pocket configured for promoting curling of the chips produced by the cutting edges, the pocket having a rake face adjacent the land surface, opposing side walls extending upward from the rake face and a generally arcuate back wall interconnected with the rake face and the opposing side walls.

2. The cutting insert of claim 1, wherein the rake face of each pocket slopes generally downwardly away from the land surfaces.

3. The cutting insert of claim 1, wherein the back walls of the pockets terminate in generally arcuate upper edges on the upper chip surface such that the arcuate upper edges of the back walls are elevated above the cutting edges.

4. The cutting insert of claim 1, further including the pockets having intermediate side walls between the rake face and each of the opposing side walls.

5. The cutting insert of claim 4, further including the pockets having intermediate back walls between the rake face and the back wall, wherein each intermediate back wall is interconnected with the intermediate side walls.

6. The cutting insert of claim 5, further including each chip divider having an intermediate leading chip dividing portion between the land surface and the leading chip dividing portion.

7. The cutting insert of claim 1, wherein the elongated face of the leading chip dividing portion is rounded.

8. The cutting insert of claim 1, wherein the polygonal body includes one of a square or trigonal shape.

9. A cutting insert for cutting a workpiece by removing chips of material therefrom, comprising:
a polygonal body having an upper chip surface, a bottom surface and peripheral side surfaces extending between the upper chip surface and the bottom surface, the peripheral side surfaces intersecting the upper chip surface to form cutting edges therewith, and land surfaces disposed adjacent the cutting edges; and
a plurality of chip dividers disposed about a periphery of the upper chip surface to divide the chips produced by the cutting edges, each chip divider including a leading chip dividing portion having an elongated face and extending generally angularly upwardly adjacent to the land surface,
wherein adjacent chip dividers define a pocket that includes a bottom region having a rake face portion adjacent the land surface and a back wall portion rearward of the rake face portion, and opposing side walls extending upward from the rake face portion and the back wall portion such that the back wall portion is configured for promoting curling of the chips produced by the cutting edges.

10. The cutting insert of claim 9, wherein the rake face portion of each pocket slopes generally downwardly away from the land surfaces.

11. The cutting insert of claim 10, wherein the back wall portion of each pocket slopes generally upwardly away from the rake face portion.

12. The cutting insert of claim 11, wherein the back wall portions of the pockets terminate in upper edges on the upper chip surface such that the upper edges of the back wall portions are elevated above the cutting edges.

13. The cutting insert of claim 11, wherein the bottom regions of the pockets have a transition zone between the rake face portion and the back wall portion to provide for a transition between the rake face portions sloping generally downwardly away from the land surfaces and the back wall portions sloping generally upwardly away from the rake face portions.

14. The cutting insert of claim 9, further including the pockets having intermediate side walls between the rake face portions and each of the opposing side walls and between the back wall portions and each of the opposing side walls.

15. The cutting insert of claim 14, further including each chip divider having an intermediate leading chip dividing portion between the land surface and the leading chip dividing portion.

16. The cutting insert of claim 9, wherein the elongated face of the leading chip dividing portion is rounded.

17. The cutting insert of claim 9, wherein the polygonal body includes one of a square or trigonal shape.

18. A cutting insert for cutting a workpiece by removing chips of material therefrom, comprising:
a polygonal body having an upper chip surface, a bottom surface and peripheral side surfaces extending between the upper chip surface and the bottom surface, the peripheral side surfaces intersecting the upper chip surface to form cutting edges therewith; and
a plurality of chip dividers spaced apart and disposed at least partially about a perimeter of the upper chip surface to divide the chips produced by the cutting edges, each chip divider including a leading chip dividing portion adjacent to the cutting edge and extending generally upwardly from the cutting edge, the leading chip dividing portion having an elongated, rounded face,
wherein adjacent chip dividers define a pocket having a rake face adjacent the cutting edge, a back wall rearward of the rake face and opposing side walls extending rearward from respective leading chip dividing portions of the adjacent chip dividers such that the pockets are configured for promoting curling of the chips produced by the cutting edges.

19. The cutting insert of claim 18, wherein the back wall of each pocket is generally arcuate.

20. The cutting insert of claim 18, wherein the rake face of each pocket slopes generally downwardly away from the cutting edges and the back wall of each pocket slopes generally upwardly away from the rake face.
